(19) United States
(12) Patent Application Publication
(10) Pub. No.: US 2018/0330342 A1
(43) Pub. Date: Nov. 15, 2018

(54) DIGITAL ASSET ACCOUNT MANAGEMENT

(71) Applicants: Gyan Prakash, Foster City, CA (US); Ajit Gaddam, Sunnyvale, CA (US); Sivanarayana Gaddam, Santa Clara, CA (US)

(72) Inventors: Gyan Prakash, Foster City, CA (US); Ajit Gaddam, Sunnyvale, CA (US); Sivanarayana Gaddam, Santa Clara, CA (US)

(21) Appl. No.: 15/592,965

(22) Filed: May 11, 2017

(51) Int. Cl. G06Q 20/06; G06Q 20/40

(52) U.S. Cl. CPC G06Q 20/065; G06Q 2220/00; G06Q 20/4014

(57) ABSTRACT

Systems and methods related to cryptocurrency system that enables transactions to be performed using digital assets corresponding to an amount of fiat currency. The cryptocurrency system includes a digital asset service provider computer that can host a digital asset account on behalf of an intended recipient of a transfer (e.g., an unbanked user). In some embodiments, a transfer recipient may elect to receive the transfer in the form of a digital asset. The digital asset service provider computer may facilitate a fund transfer by a financial institution to hold currency with which the digital asset is backed. The digital asset may be generated and managed by the digital asset service provider computer as a blockchain ledger of transactions that cryptographically secures data that is stores. In some embodiments, a payment method identifier may be generated for the digital asset and utilized by the transfer recipient to perform subsequent transactions.

### BACKGROUND

Transferring data between user devices electronically has become commonplace. For example, a user may perform a data transfer via an application to send money to a friend or family member. Typically, the recipient of such transactions is required to have an account with an entity (e.g., a financial institution). An account can indicate that a user can be trusted because the entity has already conducted an authentication process for the user. If the recipient has an account, the account information may be utilized to authenticate the user, making the transaction more secure. However, if the recipient doesn't have an account with the entity, the transaction may not be conducted. Furthermore, conducting a transaction without requiring the recipient to have an account may be insecure since relatively little is known about the recipient. As a result, were transactions performed with such users, the transactions would be performed with insufficient security.

Once users are able to accumulate data from data transfers it can be cumbersome to utilize the accumulated data. A user might have to perform an additional transfer to move the accumulated data into an account from which they can perform subsequent transactions. This causes delay and wasteful data processing.

Embodiments of the present invention address these and other problems, individually and collectively.

### BRIEF SUMMARY

One embodiment of the invention is related to a method for securely performing data transactions using digital assets. The method may comprise receiving, by a server computer, a transfer request associated with a first user, the transfer request comprising authentication information associated with the first user, first identification information associated with the first user, an identifier associated with a second user, and a transfer amount. The method may further comprise validating, by the server computer, the transfer request utilizing the first authentication information. The method may further comprise transmitting, by the server computer, the transfer request to a computing device of the second user utilizing the identifier associated with the second user. The method may further comprise receiving, by the server computer, a digital asset request comprising second identification information associated with the second user and a digital asset amount related to the transfer amount. The method may further comprise transmitting, by the server computer, a transaction request to an financial institution computer, the transaction request comprising the first identification information, the second identification information, and the transfer amount. The method may further comprise receiving, by the server computer, a transaction response corresponding to the transaction request. The method may further comprise generating, by the server computer, a digital asset corresponding to the digital asset amount utilizing the first identification information, the digital asset being associated with a first digital asset account of the first user. The method may further comprise transferring, by the server computer, the digital asset from the first digital asset account of the first user to a second digital asset account of the second user utilizing the first identification information and the second identification information. The method may further comprise maintaining, by the server computer, a blockchain ledger of transactions to indicate the transfer of the digital asset from the first digital asset account of the first user to the second digital asset account of the second user.

In some embodiments, a settlement process may be performed for the transfer request in real-time. In this case, an amount associated with the digital asset may be available for use by the second user in real-time.

The method may further comprise generating, by the server computer, a payment method identifier associated with the digital asset account of the second user. The method may further comprise receiving, by the server computer, an authorization request comprising the payment method identifier and a resource provider identifier. In some embodiments, the method may further comprise facilitating, by the server computer, an asset transfer between the digital asset account of the second user and a financial account associated with the resource provider identifier.

In some embodiments, the transfer request associated with the first user is received from an application executing on a first computing device of the first user and/or the transfer request is transmitted to a second computing device of the second user via an application executing on the second computing device of the second user. In some examples, the transfer request may be transmitted to the second user utilizing a text messaging protocol.

In some embodiments, transmitting the transaction request message to the financial institution computer causes the financial institution computer to create a holding account on behalf of the second user and transfer the transfer amount from an electronic account of the first user to the holding account.

Another embodiment of the invention is related to a server computer that comprises one or more processors and computer readable medium coupled to the one or more processors. The computer readable medium comprises code executable by the one or more processors to implement the methods described herein.

Another embodiment of invention is directed to a financial institution computer comprising one or more processors and a computer readable medium coupled to the one or more processors. The computer readable medium may comprise code, executable by the one or more processors to implement methods described herein.

Another embodiment of invention is directed to a computing device of a user comprising one or more processors and a computer readable medium coupled to the one or more processors. The computer readable medium may comprise code, executable by the one or more processors to implement methods described herein. For example, the method may comprise receiving, from a server computer, a transfer request associated with a transferor, the transfer request comprising a transfer amount. The method may further comprise providing an option to request the transfer amount to be provided as a digital asset, the option being provided to a user of the user computing device utilizing the display. The method may further comprise receiving user input indicating that the option has been selected. The method may further comprise collecting user identification information of the user. The method may further comprise transmitting, to the server computer, a digital asset request comprising the user identification information and a digital asset amount related to the transfer amount, wherein receipt of the digital asset request causes the digital asset service provider computer to facilitate a transfer of the digital asset from the transferor to the user utilizing a blockchain ledger of transactions. The method may further comprise receiving notification that the digital asset has been transferred. The method may further comprise presenting the notification to the user at the display.

These and other embodiments of the invention are described in further detail below.

### BRIEF DESCRIPTION OF THE DRAWINGS

FIG. 1 shows a block diagram showing various elements of a cryptocurrency system according to some embodiments.

FIG. 2 shows a block diagram of an exemplary computer architecture for a service provider computer according to some embodiments.

FIG. 3 depicts an example user interface 300 provided by the service provider computer (e.g., the service provider computer 112 of FIG. 1) according to some embodiments.

FIG. 4 shows a block diagram of an exemplary computer architecture for a digital asset service provider computer according to some embodiments.

FIG. 5 shows a digital asset service provider computer hosting digital asset accounts and digital asset management services according to embodiments of the present invention.

FIG. 6 shows a system 600 with a detailed flow diagram of a transaction in which a digital asset may be generated and maintained on behalf of a user.

FIG. 7 shows an exemplary system according to embodiments of the present invention.

Prior to discussing embodiments of the invention, descriptions of some terms may be helpful in providing a better understanding of the invention.

“Digital currency” may refer to units of value that may be used as a form of payment for transactions, including financial transactions. Digital currency may be currency that is electronically generated by and stored at a user computing device. Digital currency may be purchased using conventional forms of currency (e.g., fiat currency) and generated with a specific value. Typically, the digital currency may not have a physical form of tender but may be accessible through a user computing device (e.g., mobile device) using a software application such as a digital wallet or mobile application. A type of digital currency may be cryptocurrency, which utilizes cryptographic methods for verification.

A “digital asset” may refer to digital content associated with a value. In some cases, the digital asset may also indicate a right to use the value and other attributes associated with the digital asset. For example, a digital asset may be data that indicates a digital currency value, such as a cryptocurrency value. The digital asset may also indicate a plurality of digital asset attributes, such as a bank identification number (BIN) identifier, a digital asset identifier, a timestamp, an acquirer public key, a resource provider identifier, and resource provider location. In other embodiments, the digital asset may correspond to other non-currency values, such as access privileges data (e.g., number of authorized usages) and time limit data.

A “digital asset service provider computer” may refer to one or more server computers that function to operate and maintain a cryptocurrency system. The digital asset service provider computer may function to facilitate the generation/issuance and distribution of digital currency between devices within a cryptocurrency system. The digital asset service provider computer may also function to enable the performance of transactions between devices for the transfer or goods/services and/or the transfer of funds. In some embodiments, the digital asset service provider computer may be configured to utilize one or more separate computing devices (e.g., computing nodes) to manage a ledger of transactions (e.g., a blockchain), while in other embodiments, the digital asset service provider computer may be configured to manager a ledger of transactions directly.

A “service provider computer” may be a computing device provided by an entity (e.g., a bank). In some embodiments, the service provider computer may manage and provide services to a user related to an online banking account. The services may be provided to the user via an application associated with the service provider computer (e.g., an online banking application) and stored on a user device. A service provider computer may be configured to send over-the-air (OTA) messages to an application stored on the user device. In at least one example, the service provider computer may be responsible for providing one or more network pages (e.g., an online banking website) associated with the entity. The service provider computer may be accessed via a website accessible to a user device. This website may be configured to be accessible from an application (e.g., a browser application, an online banking application, a digital wallet application, etc.) operating on the user device. In some embodiments, a service provider computer may be configured to handle service call requests from an application operating on a user device. The service provider computer may be configured to serve, in response to received requests, various user interfaces that may be rendered at the user device.

An “online banking account” may be an account managed by a financial institution that can be accessed via the Internet. An online banking account can store user profile information, payment account information, bank account information, and/or the like.

A “ledger of transactions” may refer to a compilation of data from previous transactions. The ledger of transactions may be a database or other comparable file structure that may be configured to store data from all previous transactions performed using a digital currency, including the date and time of the transaction, the transaction amount, and identification information for the participants of the transaction (e.g., the sender and the receiver of the transaction amount). In some embodiments, the ledger of transactions may be in the form of an electronic ledger (e.g., a blockchain) in which data already stored in the electronic ledger is unalterable, or at least, tamper resistant. In some embodiments, a cryptocurrency system may operate multiple computing devices (e.g., computing nodes) that individually store a copy of the ledger of transactions. In some embodiments, only some computing devices of the cryptocurrency system may store a copy of the ledger of transactions.

A “computing node” may be a device or module that enables management of the generation, assignment, and/or management of digital assets. In some embodiments, the computing node may be managed by a digital asset service provider computer, which may utilize the computing node to generate a digital asset, update a ledger of transactions, or the like.

A “digital signature” may refer to an electronic signature for a message. In some embodiments, the digital signature may be used to validate the authenticity of a transaction message sent within a cryptocurrency system. A digital signature may be a unique value generated from a message and a private key using an encrypting algorithm. In some embodiments, a verification algorithm using a public key may be used to verify the signature. The digital signature may be a numeric value, an alphanumeric value, or any other type of data including a graphical representation.

A “key” may refer to a piece of data or information used for an algorithm. A key may be a unique piece of data and is typically part of a key pair where a first key may be used to encrypt a message, while a second key may be used to decrypt the encrypted message. The key may be a numeric or alphanumeric value and may be generated using an algorithm. A management system server computer in a cryptocurrency payment network may generate and assign a unique key pair for each node in the cryptocurrency payment network.

A “key pair” may include a pair of encryption keys, such as a public key and a corresponding private key. The key pair may be generated by a server computer (e.g., a digital asset service provider computer) associated with the cryptocurrency system. The public key may be distributed throughout the cryptocurrency system in order to allow for authentication of various messages signed by a user device using the corresponding private key.

“Authentication information” may include any data suitable for authenticating a user and/or mobile device. Authentication information may be initially obtained from a user or a device that is operated by the user. Examples of authentication information obtained from a user may include PINs (personal identification numbers), passwords, etc. Examples of authentication information that may be obtained from a device may be include device serial numbers, digital signatures, hardware secure element identifiers, device fingerprints, biometric information of the user, phone numbers, IMEI numbers, etc.

A “financial institution server computer” may refer to a computer associated with a financial institution (e.g., a bank). Examples of financial institution server computers may include an access device, terminal, or a web server computer hosting a financial institution server Internet website. The financial institution server computer may be in any suitable form. Additional examples of financial institution server computers include any device capable of accessing the Internet, such as a personal computer, cellular or wireless phones, personal digital assistants (PDAs), tablet PCs, and handheld specialized readers.

A “resource providing computer” may refer to a computer associated with a resource providing entity that may make resources available to a user. A resource providing entity may also be known as a resource provider. Examples of resource providers include distributors, merchants, vendors, suppliers, owners, traders, and the like. In some embodiments, such entities may be a single individual, small groups of individuals, or larger groups of individuals (e.g., companies). Resource providers may be associated with one or more physical locations (e.g., supermarkets, malls, stores, etc.) and online platforms (e.g., e-commerce websites, online companies, etc.). At the physical locations, the resource provider may host an access device. In some embodiments, resource provider may make available physical items (e.g., goods, products, appliances, etc.) to the user. In other embodiments, resource provider may make available digital resources (e.g., electronic documents, electronic files, etc.) or time (e.g., rental time, use time, etc.) to the user. In other embodiments, resource providers may manage access to certain resources by the user.

A “transfer request” may be an electronic message that may be utilized to request a transfer. In some embodiments, a transfer request may initiate a process for transferring digital currency from one user to another. A transfer request may include authentication information of the requestor (e.g., name, address, account number, digital signature, social security number, password, pin, username, or the like) and a transfer amount. In some embodiments, the transfer amount may be in denominations of fiat currency (e.g., U.S. Dollars).

A “digital asset request” may be an electronic message that may be utilized to request a digital asset. In some embodiments, a digital asset request may indicate that a user is requesting to receive a transfer amount in the form of a digital asset. In some embodiments, a digital asset request may include at least one of identification information of the requestor (e.g., driver's license number, date of birth, name, address, account number, digital signature, social security number, password, pin, username, or the like) and a digital asset amount. The digital asset amount may be in denominations of fiat currency (e.g., U.S. Dollars) or cryptocurrency (e.g., “Big Bucks”).

A “transaction request” may be an electronic message that may be utilized to request transaction processing from another computing device. In some embodiments, a transaction request may be utilized to cause a financial institution computer (or a component of a financial institution computer) to create a holding account (e.g., an online banking account) on behalf of a user (e.g., an intended recipient of a transfer). In some embodiments, receiving a transaction request may cause a financial institution computer to transfer an amount of fiat currency from an account of a first user to a holding account maintained on behalf of a second user.

A “transaction response” may be an electronic message that provides information related to a transaction request. In some embodiments, it may be an electronic message that is sent from a financial institution computer (or a component of a financial institution computer) that confirms that a holding account has been identified and/or created for a particular user (e.g., an intended recipient of a transfer). Generally, a transaction response may provide a status (e.g., success, failure, etc.) related to a corresponding transaction request.

An “authorization request” may be an electronic message that is used to authorize a payment for a financial transaction. In some examples, an authorization request is sent to a payment processing network and/or an issuer of a payment card to request authorization for a transaction. An authorization request according to some embodiments may comply with ISO 8583, which is a standard for systems that exchange electronic transaction information associated with a payment made by a consumer using a payment device or payment account. The authorization request may include an account identifier that may be associated with a payment device (e.g., a debit and/or credit card) or payment account (e.g., an online banking account). An authorization request may also comprise additional data elements corresponding to “identification information” including, by way of example only: a service code, a CW (card verification value), a dCW (dynamic card verification value), an expiration date, etc. An authorization request may also comprise “transaction information,” such as any information associated with a current transaction, such as the transaction amount, merchant identifier, merchant location, etc., as well as any other information that may be utilized in determining whether to identify and/or authorize a transaction.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

### DETAILED DESCRIPTION

Embodiments of the present invention are directed to a cryptocurrency system that enables transactions to be performed between entities with digital assets corresponding to cryptocurrency amounts. The cryptocurrency system may comprise a digital asset service provider computer that can host digital asset accounts associated with individual users (e.g., individual persons, entities, resource providers, etc.). The digital asset service provider computer (or a separate service provider computer of the cryptocurrency system) may be configured to provide a user access to view and/or edit digital asset account information through an application operating on his computing device. In some embodiments, the functionality discussed herein may be embedded in an online banking application, a digital wallet application for managing digital assets, or any suitable type of application hosted by the digital asset service provider computer (or another computing device of the cryptocurrency system).

In at least one embodiment, digital assets can be utilized in transfers between two users. As a non-limiting example, a grandfather may request a transfer of some amount of fiat currency (e.g., $20 USD) to his grandson. The grandson may or may not have an existing bank account. Regardless, the grandfather may transfer money to the grandson in the form of a digital check (e.g., an image that resembles a personal check). In some embodiments, the grandson may provide the digital check as input into an online banking application to deposit funds an online banking account. Alternatively, the grandson may initiate (e.g., via an application operating on his user device) a request to receive all, or some portion, of the transfer amount as a digital asset. In this scenario, the cryptocurrency system may maintain a digital asset on behalf of the grandson corresponding to the amount requested.

The digital assets maintained by the cryptocurrency system can be used in various transactions. Continuing on with the example above, the cryptocurrency system may enable the grandson to conduct a transaction with a resource provider computer (e.g., a merchant) using the digital assets associated with his digital asset account. As a non-limiting example, the cryptocurrency system may generate and maintain a payment method identifier for the digital asset. The payment method identifier can enable the grandson to pay for a transaction for goods using his digital asset account by providing the payment method identifier (e.g., a card number) corresponding to the digital asset account.

The digital asset service provider computer may be configured to manage information related to digital asset transactions. For example, the digital asset service provider computer may store a ledger of transactions (e.g., a blockchain) over a network that records transaction data related to all transactions performed by users of the cryptocurrency system. The ledger of transactions may be updated each time a new transaction is conducted and the data stored in the ledger may serve as proof that digital assets were assigned to a certain user's digital asset account.

In some embodiments, a blockchain is a transaction database shared by all nodes participating in a system (e.g., a cryptocurrency system) based on a blockchain protocol. A blockchain may include a number of blocks of interaction records. Each block in the blockchain can contain also include a timestamp and a link to a previous block. For example, each block may include or be appended to a hash of the previous block. Stated differently, interaction records in a blockchain may be stored as a series of “blocks,” or permanent files that include a record of a number of transactions occurring over a given period of time. Blocks may be appended to a blockchain by a blockchain provider after it completes the block and the block is validated. A blockchain may be distributed (e.g., to a number of computing devices/nodes that implement the digital asset service provider computer), and a copy of the blockchain may be maintained at one or more locations. In some examples, the blockchain can be used to verify transactions. The security of a blockchain may be obtained using a cryptographic scheme.

Embodiments of the invention provide advantages. For example, embodiments of the invention enable users such as unbanked consumers that do not have a relationship with a financial institution (e.g., bank) to perform cashless transactions in a secure manner. The use of cryptographic techniques to manage the ledger of transactions (e.g., a blockchain) enables a secure system for transferring digital assets between entities since the recorded data is unalterable, or at least tamper resistant. Accordingly, transactions are enabled that were unable to be conducted and these transactions may be performed with an increased level of security by utilizing the cryptographic scheme of a blockchain. Additionally, by using a blockchain ledger, the ledger maintenance aspects of a digital asset service provider computer may be performed by multiple computing nodes operating as a distributed system where each computing node stores a copy of the blockchain ledger in memory and participates in maintaining the blockchain ledger.

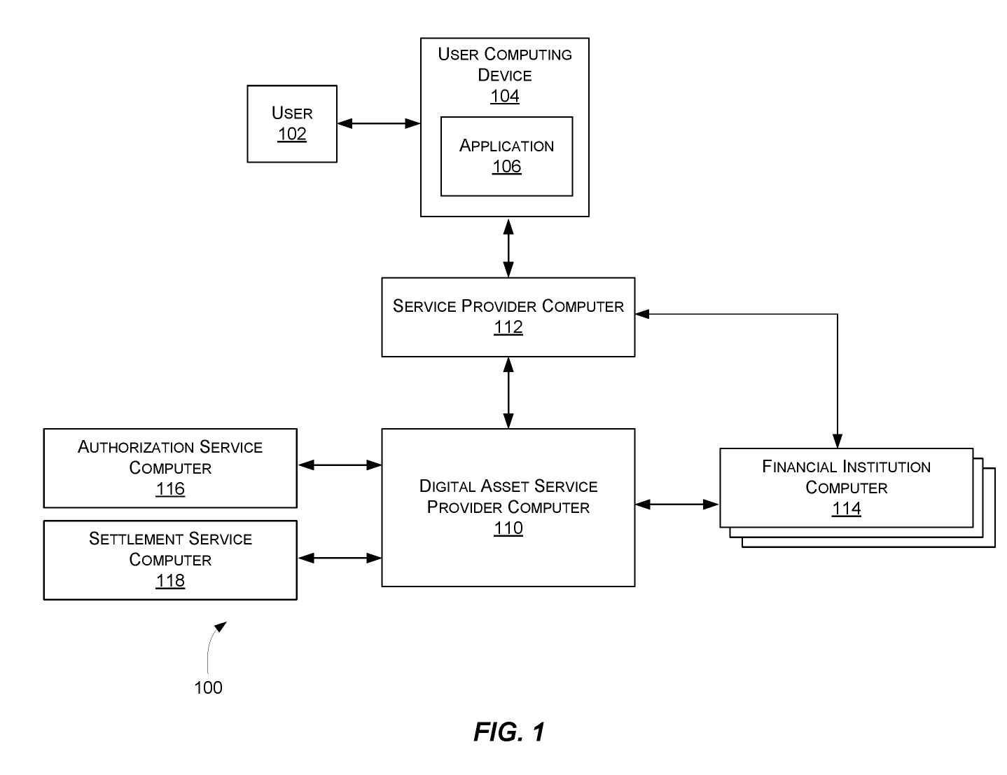

FIG. 1 shows a block diagram showing various elements of a cryptocurrency system 100 according to embodiments of the present invention. Cryptocurrency system 100 includes user computing device 104, an application 106, a digital asset service provider computer 110, a service provider computer 112, an authorization service computer 114, and a settlement service computer 114. Each element of the cryptocurrency system 100 may be run on a single computer or multiple systems and computers that may be in operative communication with each other via any suitable communication medium (including the Internet), using any suitable communications protocol.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. Further details related to the components shown in FIG. 1 are described with respect to other figures described herein.

The user computing device 104 may have any suitable characteristics. The user computing device 104 may include a processor and a computer readable medium coupled to the processor, the computer readable medium comprising code, executable by the processor for performing the functionality described herein. The user computing device 104 may be communicatively coupled to the service provider computer 112 via a communications medium in order to exchange data with service provider computer 112.

The user computing device 104 may be in any suitable form. Examples of user computing device 104 includes any device capable of accessing the Internet, such as a personal computer, cellular or wireless phones, personal digital assistants (PDAs), tablet computers, laptop computers, and handheld specialized readers. The user computing device 104 may exchange data through a communications medium with the service provider computer 112. In some embodiments of the invention, the user computing device 104 may additionally, or alternatively, exchange data through a communications medium with the digital asset service provider computer 110.

In some embodiments, user computing device 104 may include an application 106 (e.g., a browsing application, an online banking application, etc.) stored in memory and configured to retrieve, present, and send data across a communications network (e.g., the Internet). In some embodiments, the application 106 may be used to exchange data (e.g., via application programming interface service calls) with service provider computer 112 and/or digital asset service provider computer 110.

Service provider computer 112 (e.g., a server computer) may be configured to enable a user (e.g., user 102) to access services provided by the cryptocurrency system 100. For example, service provider computer 112 may host application 106 operating on user computing device 104. Application 106 may be configured to provide the user 102 the ability to view, update, and manage information associated with a digital asset account that is managed by digital asset service provider computer 110. The user 102 may utilize the application 106 to perform a transaction. For example, the user 102 may utilize the application to instruct a transfer from his account to other accounts, as well as receive transfers of digital assets to his account.

In some embodiments, the service provider computer 112 may be configured to receive and transmit transfer requests and/or digital asset requests. Additionally, the service provider computer 112 may be configured to transmit any suitable data via a text messaging protocol (e.g., Multimedia Messaging Service (MMS), Short Message Service (SMS), etc.) or any suitable electronic means to convey data from one device to another. It should be appreciated that any functionality discussed herein in reference to service provider computer 112 may additionally, or alternatively, be provided by the digital asset service provider computer 110. In some embodiments, service provider computer 112 and digital asset service provider computer 110 may be a single computing device or a single computing system.

In some embodiments, digital asset service provider computer 110 (e.g., a server computer) may be configured to manage digital asset accounts on behalf of a variety of users (e.g., individual, entities, merchants, etc.). The digital asset service provider computer 110 may further manage digital assets corresponding to each digital asset account. Digital asset service provider computer 110 may provide services such as mapping digital assets to fiat currency amounts, allocating/assigning digital assets to a digital asset account, and facilitating the process of converting fiat currency to digital asset and vice versa.

By way of example, digital asset service provider computer 110 may be configured to receive transfer requests indicating a user's desire to transfer a particular amount of fiat currency to another user. In some embodiments, the digital asset service provider computer 110 may be configured to validate the transfer request using authentication information received in the transfer request (e.g., a digital signature of the first user). The digital asset service provider computer 110 may be configured to transmit a transaction request to financial institution computer 114.

Upon receipt, the financial institution computer 114 may be configured to perform one or more authentication procedures for authenticating the transferor and/or the transferee. Upon authenticating one or more of the parties to the transaction request, the financial institution computer 114 may be configured to transfer an amount of digital currency from an online banking account of the transferor to an online banking account of the transferee. The online banking account of the transferee may have existed prior to the receipt of the transfer request or the online banking account (hereinafter referred to as a “holding account”) may have been generated by the financial institution computer 114 in response to receiving the transaction request. In some embodiments, the financial institution computer 114 may be configured to transmit a transaction response to the digital asset service provider computer 110. The transaction response may indicate a status associated with the transfer (e.g., success, failure, busy, etc.).

Upon receiving a transaction response that indicates a transfer of digital currency was successful, or at any suitable time, the digital asset service provider computer 110 may be configured to generate a digital asset corresponding to a requested transfer amount. In some embodiments, the digital asset service provider computer 110 may be configured to record information related to the creation of the digital asset and/or the assignment of the digital asset to an entity (e.g., a user, a merchant, etc.). The digital asset service provider computer 110 may be configured to manage the information by recording relevant data in a ledger of transactions. In some embodiments, the ledger of transactions may be in the form of a blockchain where each new block in the blockchain references previous blocks (e.g., a hash of previous block) such that any tampering of data stored in these previous blocks cannot go undetected. Thus, a ledger of transaction maintained by the digital asset service provider computer 110 may be, at the very least, tamper resistant. It should be appreciated that any functionality discussed in reference to digital asset service provider computer 110 may be additionally, or alternatively, provided by one or more computing devices (e.g., computing nodes of a distributed processing system implementing at least some of the functionality of the digital asset service provider computer 110).

Authorization service system 116 and settlement service system 118 may enable authorization, clearing, and settling for transactions conducted using the cryptocurrency system 100. In some embodiments, authorization and clearing processes may be performed in real time, while settlement processes may be conducted at the end of the day during which real cryptocurrency value is transferred. In other embodiments, certain settlement processes may be conducted in real-time in order to enable consumers to utilize cryptocurrency corresponding to digital assets immediately upon claiming the digital assets.

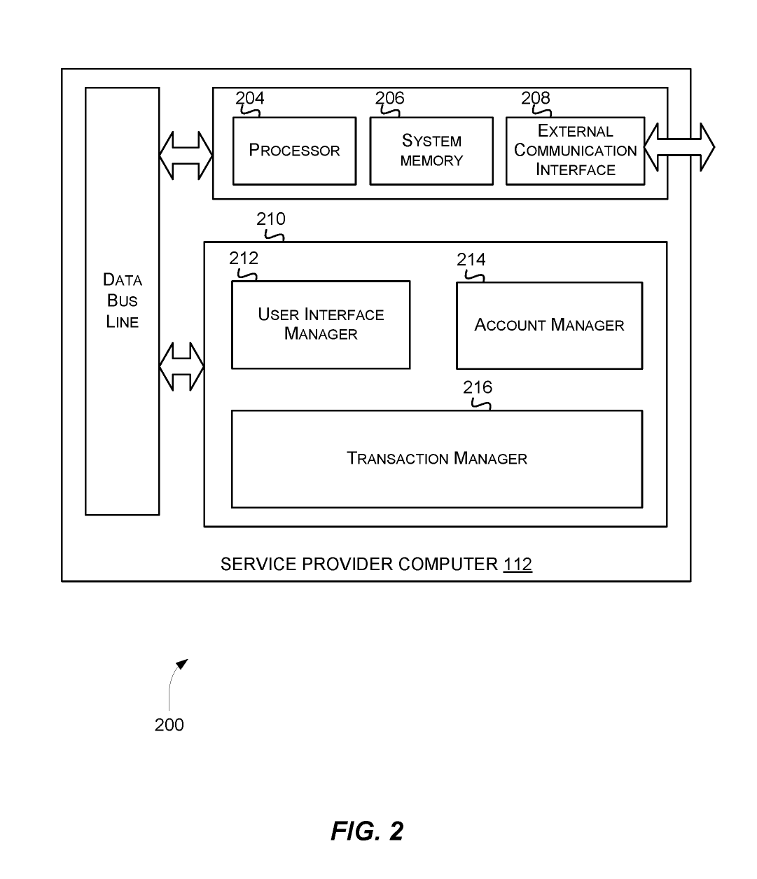

FIG. 2 shows a block diagram of exemplary computer architecture 200 for a service provider computer (e.g., the service provider computer 112 of FIG. 1) according to some embodiments. The service provider computer 112 may comprise a processor 204, which may be coupled to a system memory 206 and an external communication interface 208. A computer readable medium 210 may also be operatively coupled to the processor 204. The computer readable medium 210 may comprise a number of software modules including a user interface manager 212, an account manager 214, and a transaction manager 216. The modules of the service provider computer 112 may be software and/or hardware modules. It should be appreciated that any functionality described with respect to the modules of FIG. 2 may be combined to be performed by a single module or may be performed by a module that is external to the service provider computer 112.

In some embodiments, the service provider computer 112 may be configured to facilitate services provided by the digital asset service provider computer 110. These services may be provided to a user via an application (e.g., the application 106 of FIG. 1) associated with the service provider computer 112. The application may operate at a user computing device. In at least some embodiments, the service provider computer 112 may be configured to send over-the-air (OTA) messages to the application operating at the user computing device.

In some embodiments, the service provider computer 112 may be responsible for providing one or more network pages associated with a financial institution (e.g., a bank) or a digital asset provider. The functionality provided by the components of the service provider computer 112 may be accessed via a website hosted by the service provider computer 112 and accessible to the user computing device 104. This website may be configured to be accessible from an application (e.g., a browser application, an online banking application, a digital wallet application, etc.) operating on the user computing device 104.

The user interface manager 212, a component of the service provider computer 112, may be configured to cause the processor 204 to process service calls received from the application 106. Upon receipt of a service call, the user interface manager 212 may be configured to serve a variety of user interfaces that may be rendered at the user computing device 104 (e.g., via the application 106).

By way of example, the user interface manager 212 may be configured to cause the processor 204 to transmit data to render a user interface at the user computing device 104. One such interface may be associated with collecting registration information of a user. Any suitable interface elements may be utilized within any user interface discussed herein such as drop down menus, edit boxes, text fields, radio button, or the like. Registration information may include identification information such as a name, address, phone number, banking account number, username, password, pin, or the like. Additional example user interfaces provided by the user interface manager 212 may include user interfaces for presenting account information (e.g., banking account information, digital asset account information, or the like), requesting a transfer, accepting a transfer, and/or for obtaining/providing any suitable information related to any functionality discussed herein.

In some embodiments, the account manager 214, a component of the service provider computer 112, may be configured to cause the processor 204 to receive and process data (e.g., registration information) provided by the user via the application 106. The account manager 214 may cause the processor 204 to store such data within memory 210 (e.g., within a user profile) or at another suitable storage location (e.g., a storage location external to the service provider computer 112). Additionally, or alternatively, the account manager 214 may be configured to cause the processor 204 to exchange information with a computing system responsible for maintaining an account associated with a user (e.g., the financial institution computer 114 of FIG. 1, the digital asset service provider computer 110 of FIG. 1, or the like).

The account manager 214 may be configured to cause the processor 204 to store user profile information, payment account information, bank account information, and/or the like and can be used in a variety of transactions, such as but not limited to eCommerce, money transfer/personal payments, mobile commerce, proximity payments, and/or the like for retail purchases, digital goods purchases, utility payments, transferring funds between users, and/or the like.

As a non-limiting example, the account manager 214 may be configured to cause the processor 204 to retrieve banking account information (e.g., account balance, account transaction information, etc.) from a financial institution computer (e.g., the financial institution computer 114) associated with the user. In some embodiments, the account manager 214 may be configured to cause the processor 204 to retrieve digital asset account information (e.g., account balance, account transaction information, etc.) from a digital asset service provider computer (e.g., the digital asset service provider computer 110). In at least one example, registration received by the account manager 214 may be utilized to retrieve account information or any suitable information related to the user. The account manager 214 may be configured to cause the processor 204 to provide account information, or any suitable information, to the user interface manager 212 for presentation within an application operating at a user computing device.

In some embodiments, the transaction manager 216, a component of the service provider computer 112, may be configured to cause the processor 204 to receive and process a variety of transactions. Transactions may include transfer requests/responses, digital asset requests/responses, or the like.

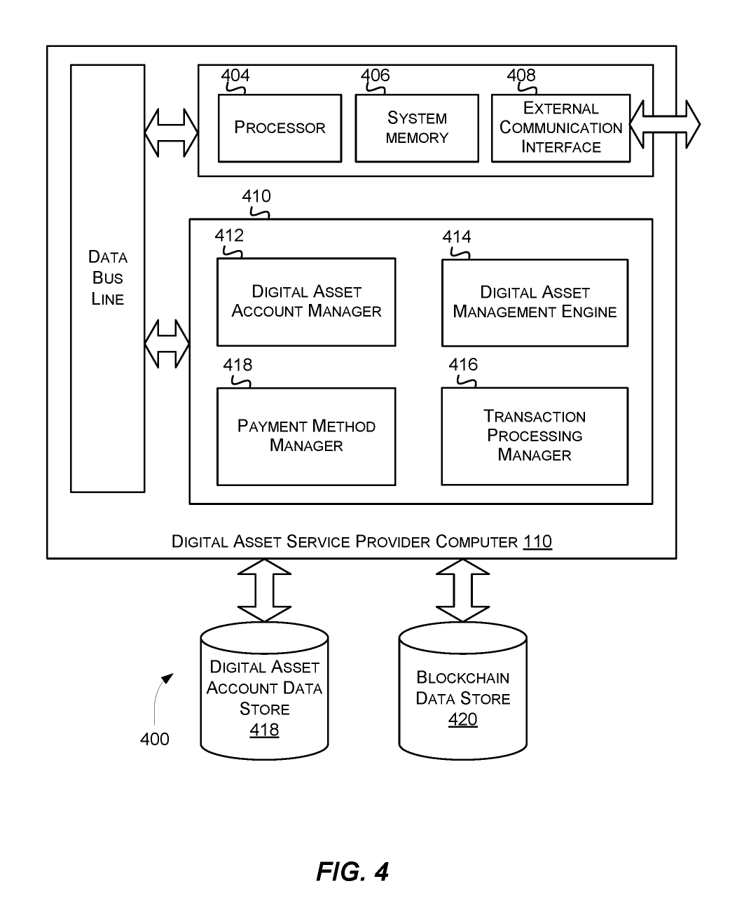

By way of example, a transfer request may be initiated by the user (e.g., via an application operating at the user computer device) from a user interface provided by the user interface manager 212. The received transfer request may relate to a transaction between two entities (e.g., a first user and a second user, a user and a merchant, or any suitable combination of two suitable entities). The transaction manager 216 may be configured to cause the processor 204 to transmit at least a portion of the transfer request to the digital asset service provider computer 110 discussed further in FIG. 4. In some examples, the transfer request may include identification information of the first user, identification information of the second user, and a transfer amount. The transaction manager 216 may subsequently cause the processor 204 to process a transfer response related to the transfer request. Processing a transfer response may include providing information received in the transfer response to the user interface manager 212 for presentation within the application operating at a user computing device.

In general, the service provider computer 112 may transmit and receive any suitable data between the service provider computer 112 and the application 106 and/or between the service provider computer 112 and the digital asset service provider computer 110. It should be appreciated that, in some embodiments, the functionality of the service provider computer 112 may be performed by the digital asset service provider computer 110.

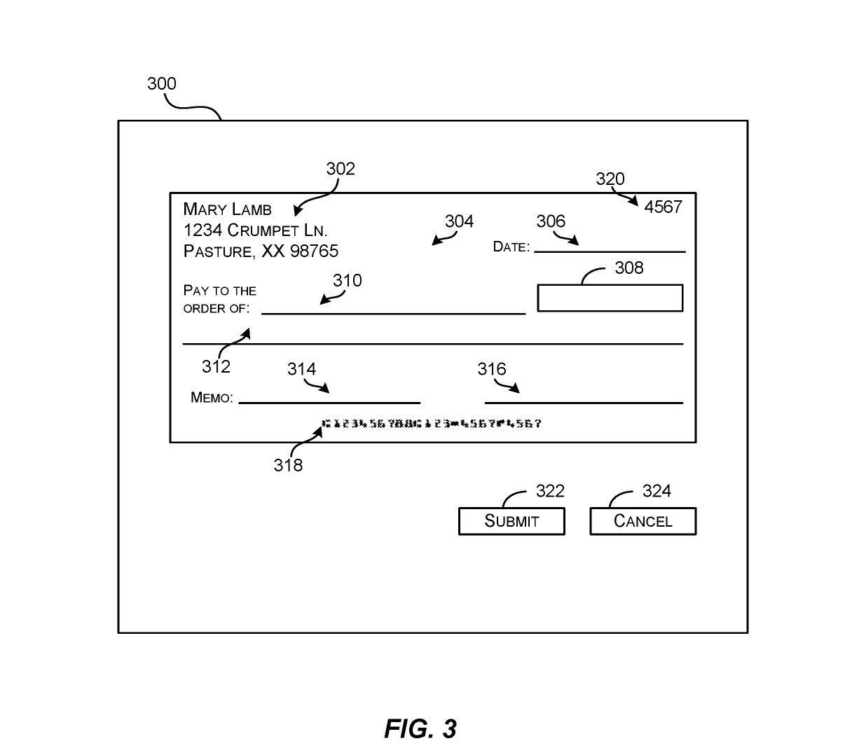

FIG. 3 depicts an example user interface 300 provided by the service provider computer (e.g., the service provider computer 112 of FIG. 1) according to some embodiments. The user interface 300 may provide the user the ability to initiate a transfer request. In at least one embodiment, the user interface 300 may include a variety of user interface elements including, but not limited to an address 302, a check image background 304, a date field 306, an amount field 308, a payee field 310, an amount descriptor field 312, a memo field 314, a signature field, 316, a check identifier 318, a check number 320, a submit button 322 and a cancel button 324. The user interface 300 is illustrative in nature and any combination of the depicted user interface elements may be utilized. The user interface 300 may be formatted to emulate the look of a physical check as depicted in FIG. 3, or the user interface 300 may be in any suitable form.

In some embodiments, the address 302 may be presented within the user interface 300. The address 302 may be situated as depicted in FIG. 3, or the address 302 may be provided elsewhere in the user interface 300. In at least one embodiment, the address 302 may be ascertained by the service provider computer 112 from user profile information maintained by the account manager 214, or the address 302 may be entered by a user at the user interface 300.

In some embodiments, the check image background 304 may be presented within the user interface 300. In some embodiments, the user may select an area within the check image. Upon selection, the service provider computer 112 may cause an option to modify the check image background 304 to provide the user with the ability to customize the look of an image to be transmitted in a transfer request. By way of example, the user may modify the color and/or select a background image from a set of predetermined images, or in some cases, the user may select a personal photo to be utilized as the check image background 304. The service provider computer 112 may be configured to cause the check image background 304 to conform to the user's selections.

In some embodiments, the date field 306 may be presented within the user interface 300. The date field 306 may be situated as depicted in FIG. 3, or the date field 306 may be provided elsewhere in the user interface 300. In at least one embodiment, the date field 306 may be user-editable and/or the date field may be automatically populated by the service provider computer 112 with a date corresponding to the current date. The service provider computer 112 may validate the date field 306 to ensure that the date provided conforms to standard date formats and acceptable field ranges.

In some embodiments, the payee field 310 may be presented within the user interface 300. The payee field 310 may be situated as depicted in FIG. 3, or the payee field 310 may be provided elsewhere in the user interface 300. In at least one embodiment, the payee field 310 may be user-editable. For example, the user may select an area relatively near the line corresponding to the payee field 310 to enter a payee identifier (e.g., a payee name). In some examples, selection of the area near the line may present the user with an option to search and select a user from a known set of users. If the payee cannot be found in the set of known users, the user may be provided the ability to enter in additional identification information (e.g., a phone number and/or email address of the payee). Upon selecting a payee or entering a payee identifier, the payee may be indicated within the payee field 310.

In some embodiments, the amount field 308 may be presented within the user interface 300. The amount field 308 may be situated as depicted in FIG. 3, or the amount field 308 may be provided elsewhere in the user interface 300. In at least one embodiment, the amount field 308 may be editable by the user. By way of example, the user may select an area corresponding to the amount field 308 to input a currency amount. The service provider computer 112 may validate the amount field 308 to ensure that the currency amount provided conforms to standard currency formats. In some examples, the user may be provided the ability to select a currency type (e.g., U.S. Dollar, Yen, Lira, etc.). The currency amount inputted may be displayed within the amount field 308 and the currency type may be indicated within the user interface 300.

In some embodiments, the amount descriptor field 312 may be presented within the user interface 300. The amount descriptor field 312 may be situated as depicted in FIG. 3, or the amount descriptor field 312 may be provided elsewhere in the user interface 300. In at least one embodiment, the amount descriptor field 312 may be editable by the user. By way of example, the user may select an area corresponding to the amount descriptor field 312 to input a description of the currency amount. As a non-limiting example, if the amount field 308 indicates $100.00 USD, the user may type in the text “One Hundred Dollars and 00/100.” In some examples, the amount descriptor field 312 may be automatically populated from the currency amount provided via the amount field 308. The service provider computer 112 may validate the amount descriptor field 312 to ensure that description conforms to standard description formats and in some cases, that the description matches the numerical amount corresponding to the amount field 308. The description may be displayed within the amount descriptor field 312 prior to and/or subsequent to validation.

In some embodiments, the memo field 314 may be presented within the user interface 300. The memo field 314 may be situated as depicted in FIG. 3, or the memo field 314 may be provided elsewhere in the user interface 300. In at least one embodiment, the memo field 314 may be editable by the user. By way of example, the user may select an area corresponding to the memo field 314 to input text (e.g., “For Maddie's Birthday Present”). The inputted text may be displayed within the memo field 314 prior to and/or subsequent to validation.

In some embodiments, the signature field 316 may be presented within the user interface 300. The signature field 316 may be situated as depicted in FIG. 3, or the signature field 316 may be provided elsewhere in the user interface 300. In at least one embodiment, the signature field 316 may be editable by the user. By way of example, the user may select an area corresponding to the signature field 316. Upon selection, the user may be provided an option to input an electronic signature (e.g., “/Jane Doe/”). Additionally, or alternatively, the user may be provided the option to enter a pin and/or password. The inputted/selected data may be displayed within the signature field 316 for presentation to the user or a placeholder string of characters (e.g., “******”) may be displayed to maintain secrecy of the user's pin and/or password.

In some embodiments, the check identifier 318 may be presented within the user interface 300. The check identifier 318 may be situated as depicted in FIG. 3, or the check identifier 318 may be provided elsewhere in the user interface 300. In at least one embodiment, the check identifier 318 may be ascertained by the service provider computer 112 from any suitable combination of a routing number associated with the user's bank, an account number, and the check number 320. The check number 320 may be ascertained by the service provider computer 112 from a counter maintained by the account manager 214. The check number 320 may be situated as depicted in FIG. 3, or the check number 320 may be provided elsewhere in the user interface 300.

At any suitable time, the user may select the cancel button 324 to cancel a transfer request. After entering information at the user interface 300, the user can select the submit button 322 to initiate a transfer request utilizing the information provided at the user interface 300. In at least one example, the service provider computer 112 may delay any of the validation tasks discussed above until an indication that the submit button 322 has been selected. Upon receiving such an indication, the service provider computer 112 may validate at least a portion of the inputted data.

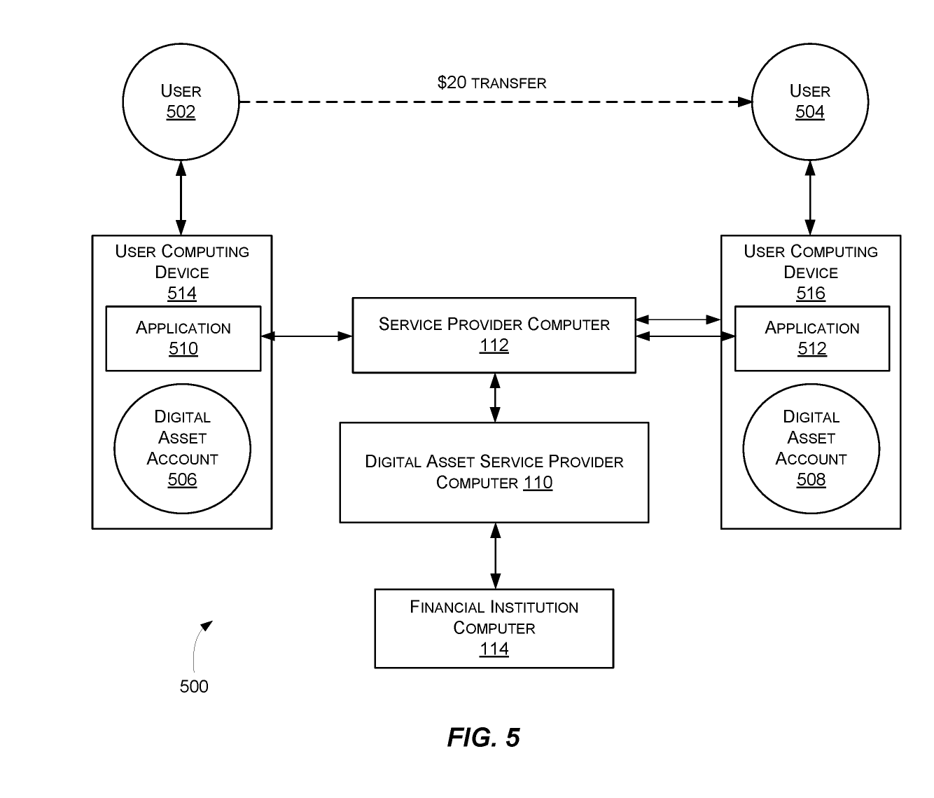

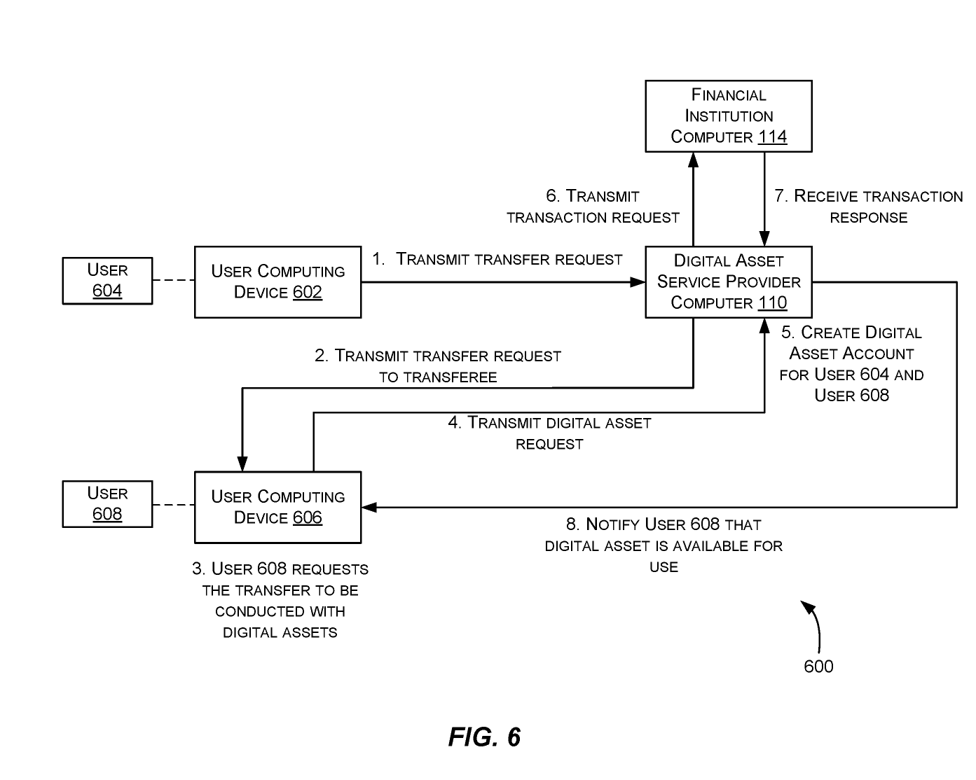

In response to receiving an indication that the submit button 322 has been selected, the service provider computer 112 may cause at least a portion of the inputted data to be stored in a transaction record associated with the user. In some embodiments, the service provider computer 112 may be configured to generate a transfer request that includes at least a portion of the inputted data. The transfer request may initiate a method for transferring digital currency from the user to the identified payee. The method is described in more detail below in connection with FIGS. 5 and 6.

FIG. 4 shows a block diagram of an exemplary computer architecture 400 for a digital asset service provider computer (e.g., the digital asset service provider computer 110 of FIG. 1) according to some embodiments. The digital asset service provider computer 110 may comprise a processor 404, which may be coupled to a system memory 406 and an external communication interface 408. A computer readable medium 410 may also be operatively coupled to the processor 404. The computer readable medium 410 may comprise a number of software modules including a digital asset account manager 412, a ledger manager 414, a transaction processing engine 416, and a payment method manager 418. The modules of the digital asset service provider computer 110 may be software and/or hardware modules. It should be appreciated that any functionality described with respect to the modules of FIG. 4 may be combined to be performed by a single module or may be performed by a module that is external to the digital asset service provider computer 110. In some embodiments, the functionality of the software/hardware modules may be executed by multiple computing nodes in a distributed environment that implement at least some functionality of the digital asset service provider computer 110.

In some embodiments, the digital asset service provider computer 110 may be configured to provide services related to managing digital assets. In at least some embodiments, the digital asset service provider computer 110 may be configured to receive and transmit data to and from the service provider computer 112 of FIG. 2 and/or the user computing device 104 of FIG. 1. In some examples, the digital asset service provider computer 110 may be configured to send and receive over-the-air (OTA) messages. At least some portion of the functionality provided by the service provider computer 112 may be provided by the digital asset service provider computer 110.

The digital asset account manager 412, a component of the digital asset service provider computer 110, may be configured to cause the processor 404 to receive and process identification information related to a user (e.g., registration information collected from a user, identification information received via a digital asset request, etc.). Upon receipt of such information, or at another suitable time, the digital asset account manager 412 may be configured to cause the processor 404 to generate a digital asset account for a user utilizing the receive registration information. The digital asset account generated may include an electronic record that stores digital asset information, user profile information, account transactions, or the like. In at least one embodiment, the digital asset account may be stored and maintained within the digital asset account data store 418, a data store accessible to the digital asset service provider computer 110.

In some embodiments, the digital asset account manager 412 may be configured to cause the processor 404 to generate, store, and/or distribute a public and/or private key of a key pair associated with a user. The key pair may be stored within the digital asset account associated with the user or as a separate electronic record associated with the user and/or the digital asset account. Once distributed to a user computing device, the private key may be utilized by the user computing device to digitally sign electronic messages. Received messages (e.g., transfer requests, digital asset requests, transaction responses, etc.) may be validated by the digital asset account manager 412 by utilizing the public and/or private key. If the received message is determined to be valid, processing may continue. If the received message is determined to be invalid, an optional notification may be provided the message initiator and further processing may be restricted or abandoned.

In some embodiments, digital asset account data store 418 stores any information related to digital assets. For example, digital asset account data store 418 may store any number of digital asset attributes (e.g., digital asset amount, currency type, timestamp, digital asset identifier, associated user identification information, etc.) for each of a plurality of digital assets. Digital asset attributes associated with a digital asset may be persisted in digital asset account data store 418 until the digital asset is converted to fiat currency or utilized in a purchase transaction.

Digital asset account data store 418 may also store payment method identifiers to be utilized for transactions. A payment method identifier (e.g., a string of alphanumeric characters, an image, or the like) may be associated with a set of one or more digital assets. In some examples, the payment method identifier may be used to pay for transactions, much like a prepaid debit card would be used, up to the total amount corresponding to the associated set of digital assets. In some embodiments, digital asset account data store 418 may store a payment method identifier until the associated digital asset has been depleted. Digital asset account data store 418 may include any hardware, software, firmware, or combination of the preceding for storing and facilitating the retrieval of information. In addition, digital asset account data store 418 may use any of a variety of data structures, arrangements, and compilations to store and facilitate the retrieval of information.

In some embodiments, the transaction processing manager 416, a component of the digital asset service provider computer 110, may be configured to cause the processor 404 to receive and process a variety of transactions. Transactions may include transfer requests/responses, digital asset requests/responses, transaction requests/response, authentication requests/response, or the like. Generally, the digital asset service provider computer 110 may be configured to cause the processor 404 to transmit and receive any suitable data messages to/from the service provider computer 112, a user computing device (e.g., the user computer device 104 of FIG. 1), and/or a financial institution computer (e.g., the financial institution computer 114 of FIG. 1).

By way of example, a transfer request may be initiated by a transferor via an application operating at the transferor's computer device. In some cases, the transfer request may be received by the transaction processing manager 416 via the service provider computer 112. The received transfer request may relate to a transfer to be conducted between the transferor and a transferee identified in the transfer request.

In some embodiments, the transaction processing manager 416 may be configured to cause the processor 404 to forward the transfer request to a computing device of the identified transferee. The transaction processing manager 416 may be configured to cause the processor 404 to identify the user device to which the transfer request may be forwarded from a user account associated with the transferee. Alternatively, the transaction processing manager 416 may forward at least some portion of the transfer request (e.g., via text message, email, or the like) utilizing data provided in the transfer request, such as the transferee's email address, phone number, or the like.

In some embodiments, a digital asset request may be initiated by the user (e.g., a transferee) via an application operating at the user's computer device. The digital asset request may be received by transaction processing manager 416, in some cases, via the service provider computer 112. In at least one embodiment, the received digital asset request may indicate a request by the user to convert an amount of fiat currency to a digital asset. By way of example, a recipient of a transfer request (e.g., a transferee) may opt to receive the amount being transferred as a digital asset. Accordingly, the digital asset request may include a digital asset amount for which a digital asset is requested. Upon receiving a digital asset request, the transaction processing manager 416 may be configured to cause the processor 404 to transmit a transaction request to a financial institution computer (e.g., the financial institution computer 114 of FIG. 1).

In some embodiments, receiving the transaction request may cause a financial institution computer to perform authentication procedures to authenticate one or both of the parties identified in the transaction request. In such cases, the financial institution computer may be configured to extract authentication information related to one or both of the parties from the transaction request. As a non-limiting example, the extracted authentication information may be compared to banking account information maintained by the financial institution computer in order to perform know-your-customer authentication techniques. If the extracted authentication information matches stored information, the corresponding party may be considered authenticated and the transaction request may proceed. If the extracted authentication information does not match stored information, the transaction request may be terminated and a transaction response transmitted indicating that the request was unsuccessful.

In some embodiments, receiving a transaction request may cause a financial institution computer to create a holding account (e.g., a temporary bank account not initiated by the transferee) on behalf of the transferee, if a holding account does not previously exist. Once a holding account has been generated, the financial institution computer 114 may perform operations to transfer digital currency corresponding to the requested transfer amount from a banking account associated with the transferor, to the holding account associated with the transferee. The financial institution computer may then be configured to transmit a transaction response to the digital asset service provider computer 110 indicating the status of the transaction request (e.g., successful, unsuccessful, etc.).

In some embodiments, the transaction processing manager 416 may be configured to receive transaction responses. Upon receiving a transaction response that indicates a corresponding transaction performed by a financial institution computer was successful, the transaction processing manager 416 may be configured to stimulate functionality provided by the digital asset management engine 414. For example, the digital asset management engine 414 may be configured to cause the processor 404 to generate a digital asset corresponding to a digital asset amount received in the transaction response. The digital asset may be maintained by the digital asset management engine 414 in an electronic ledger (e.g., a blockchain) of transactions, where each transaction in the ledger depends on a previous transaction. The electronic ledger may be stored in the blockchain data store 420. In at least one example, the digital asset management engine 414 may update the electronic ledger with an entry that includes data identifying the transferor, the transferor's digital asset account, data identifying the transferee, the transferee's digital asset account, a digital asset amount, a digital signature associated with the transferor, or any suitable combination of the above.

In some embodiments, blockchain data store 420 may be utilized to store an electronic ledger (e.g., a blockchain ledger of transactions) for all transactions (e.g., digital asset generation, digital asset transfer, etc.) performed by the digital asset service provider computer 110. The electronic ledger may be utilized to validate any transaction being performed by the digital asset service provider computer 110. Blockchain data store 420 may include any hardware, software, firmware, or combination of the preceding for storing and facilitating the retrieval of information. In addition, blockchain data store 420 may use any of a variety of data structures, arrangements, and compilations to store and facilitate the retrieval of information. In embodiments where functionality of the digital asset management engine 414 is performed by multiple computing devices, each computing device may individual access a separate blockchain data store associated with the computing device where a copy of the electronic ledger may be maintained. In these embodiments, each of the computing device may participate in distributed blockchain ledger management.

The transaction processing manager 416 may be configured to cause the processor 404 to transmit a notification via a transfer response to the intended transferor indicating whether the transfer succeeded or failed. Such information may be presented to a user (e.g., the intended transferor) in an application operating at the user's computing device.

Similarly, the transaction processing manager 416 may be configured to cause the processor 404 to transmit a notification via a digital asset response to the intended transferor indicating whether the transfer succeeded or failed. Such information may be presented to a user (e.g., the intended transferor) in an application operating at the user's computing device.

In some embodiments, the payment method manager 418 may be configured to cause the processor 404 to generate a payment method identifier and maintain an association between the payment method identifier and a set of one or more digital assets. The association may be maintained within a digital asset account stored in the digital asset account data store 418. In some examples, the payment method identifier may correspond to a prepaid debit or credit card number that may be utilized to conduct subsequent payment transactions. When the set of digital assets corresponding to the payment method identifier have been depleted, the payment method manager 418 may be configured to cause the processor 404 to delete the association.

In some embodiments, an authentication request may be received by the processor 404. The received authentication request may relate to a purchase transaction between two entities (e.g., a user and a merchant). The transaction processing manager 416 may be configured to cause the processor 404 to verify that the payment method identifier included in the authentication request is associated with a digital asset amount that is equal to or exceeds the requested transaction amount. The transaction manager 216 may subsequently cause the processor 204 to process an authentication response related to the authentication request. Processing the authentication response may include providing information received in the authentication response to the user interface manager 212 for presentation within the application operating at a user computing device.

FIG. 5 shows a digital asset service provider computer (e.g., the digital asset service provider computer 110) hosting digital asset accounts and digital asset management services according to embodiments of the present invention.

Each user of the digital asset service provider computer 110 (e.g., user 502 and user 504) may have a digital asset account managed on his behalf. For example, user 502 (e.g., a first user) may be associated with digital asset account 504 that includes information related to the digital assets assigned to user 502. Similarly, user 504 (e.g., a second user) may be associated with digital asset account 508 that includes information related to the digital assets assigned to user 504.

In some embodiments, each user may access a corresponding digital asset account through an application running on their computing devices. For example, user 502 may access digital asset account 506 through application 510 running on user computing device 514. Similarly, user 504 may access digital asset account 508 through application 512 running on user computing device 516. In some cases, the application 510 and/or the application 512 may be a digital wallet that enables, among other actions, a user to view and manage a digital asset account. The user may also use the application to view the total value of digital assets associated with their digital asset account. In some cases, the application may be further configured to provide online banking account information associated with an online banking account that is maintained by a financial institution on behalf of the user.

In some embodiments, the user 502 may use the application 510 initiate an action such as, but not limited to, a transfer request to transfer digital currency to the user 504. As a non-limiting example, the user 502 may utilize the user interface 300 provided by the application 510 to input a name, an address (physical or email), a phone number, or any suitable identifying information related to an intended transferee (e.g., the user 504). The user 502 may further input a transfer amount utilizing the user interface 300. In some cases, the user 502 may provide a pin or other authentication information (e.g., a password) at the user interface 300. A private key associated with the user 502 (stored by application 510) may be accessed in order to generate a digital signature corresponding to the user 502. The digital signature may be provided in the transfer request and utilized by the service provider computer 112, the digital asset service provider computer 110, and/or the financial institution computer 113 in order to validate data received from the application 510.

In some embodiments, the transfer request (or another data message corresponding to a different action initiated by the user) may be received by the service provider computer 112 hosting the application 510. The service provider computer 112 may forward the transfer request message to the digital asset service provider computer 110 for further processing. In some examples, the service provider computer 112 may forward the transfer request directly to the user computing device 516 via an operating system of the user computing device 516 and/or via the application 512. In some embodiments, the digital asset service provider computer 110 may validate the transfer request utilizing a digital signature provided in the transfer request. In some embodiments, if the transfer request is deemed invalid, the digital asset service provider computer 110 may cease processing the request. In some embodiments, the digital asset service provider computer 110 may forward the transfer request directly to the user computing device 516 via an operating system of the user computing device 516 and/or via the application 512. In some examples, forwarding the transfer request intended for the application 512 may be first processed by the service provider computer 112 before being provided to the application 512.

In some embodiments, a digital asset request may be received by the digital asset service provider computer 110 directly from the user computing device 516 and/or from the application 512 via the service provider computer 112. Upon receiving the digital asset request, or at another suitable time, the digital asset service provider computer 110 may generate and transmit a transaction request to financial institution computer 114.

The financial institution computer 114 may authenticate user 502 and/or user 504 utilizing data contained in the received transaction request. If the user(s) are authenticated, the financial institution computer 114 may execute instructions that cause an amount of digital currency representing fiat currency from one account (e.g., an account of the user 502) to another account (e.g., a holder account of the user 504) in accordance with the transaction request. The financial institution computer 114 may provide a status of the transaction within a transaction response directed to the digital asset service provider computer 110.

In some embodiments, receipt of the transaction response by the digital asset service provider computer 110 may cause the digital asset service provider computer 110 to generate a digital asset (e.g., 20 Big Bucks) corresponding to the transfer amount (e.g., $20). The digital asset service provider computer 110 may update a ledger (e.g., a blockchain) to record the transaction.

In some embodiments, digital asset management services provided by the digital asset service provider computer 110 may enable digital asset transactions to be recorded in a ledger of transactions using block chain technology. For example, digital asset service provider computer 110 may add entries into the blockchain ledger that correspond to transactions related to digital assets. Hence, digital asset service provider computer 110 may enable storage of a mapping between digital assets distributed by digital asset service provider computer 110 and users to which the digital assets were assigned. Additionally, the digital asset service provider computer 110 may enable storage of transactions performed using digital assets such as transfers performed using digital assets.

In some examples, the digital asset service may send one or more notifications to indicate transaction success/failure/status. For example, a notification may be provided to the user computing device 514 directly (e.g., via text message) or via the application 510) to be presented to the user 502. Similarly, the same or different notification may be provided to the user computing device 516 directly (e.g., via text message, email message, push notification, etc.) or via the application 512) to be presented to the user 504.

Embodiments of the invention enable users to receive digital assets representing fiat currency without having a direct relationship with any financial institutions. Since money received by users can be managed by digital asset service provider computer 110, the users do not need to have a card account with a financial institution and thus may be unbanked. By simply enrolling for the services provided by digital asset service provider computer 110, a user may create a digital asset account that can accumulate funds owed to the user by other users, entities, merchants, etc. In some cases, the funds can then be used by the users for new transactions (e.g., other digital asset transfers, purchase transactions, etc.). Additionally, the digital asset service provider computer 110 enables secure transactions by utilizing a blockchain ledger that may be validated according to a cryptographic scheme. Accordingly, the transaction history may be verifiable and tamper resistant which provides a greater degree of security than conventional systems.

FIG. 6 shows a system 600 with a detailed flow diagram of a transaction in which a digital asset may be generated and maintained on behalf of a user. The system 600 may include user computing device 602 operated by user 604. The system may also include user computing device 606 operated by user 608. The system 600 may further include a digital asset service provider computer 110 and a financial institution computer 114. In at least one embodiment, the digital asset service provider computer 110 may provide some or all of the functionality discussed above in connection with service provider computer 112. Two user computing device are used in FIG. 6 for illustrative purposes only, any suitable number of user computing devices may interact with the digital asset service provider computer 110 in the course of a single transaction. Although one sender (e.g., a transferor) and receiver (e.g., a transferee) are used to describe various transactions herein, it should be appreciated that data may be addressed to multiple receivers (e.g., multiple transferees) in a single data message (e.g., a transfer request).

The flow may begin at step 1 wherein a transfer request is transmitted by user computing device 602 and received by digital asset service provider computer 110. In some embodiments, the transfer request may be initiated by the user 602 via the user interface 300 of FIG. 3 or another suitable user interface. The transfer request may include any suitable information including, but not limited to, identification information associated with the intended recipient (e.g., a name, a phone number, an email address, etc.), a transfer amount, and a digital signature generated using a private key associated with the sender (e.g., the user 604). When the transfer request is received, the digital asset service provider computer 110 may be currently maintaining a digital asset account on behalf of the user 604 and/or the user 608, or alternatively, the digital asset service provider computer 110 may not be maintaining a digital asset account on behalf of one or both users.

At step 2, the digital asset service provider computer 110 may transmit a same or different transfer request to the user computing device 606 of the intended transferee (e.g., user 608). The transmission at step 2 may, in some embodiments, depend on the transfer request being validated using the private key of the sender to validate the digital signature provided in the received transfer request. The transfer request transmitted at step 2 may contain at least a portion of the data contained in the transfer request transmitted at step 1. In some examples, the transfer request transmitted at step 2 may be provided directly to the user computing device 606 (e.g., via an email, via a text message, etc.). Upon receiving the transfer request, the user computing device 606 may be configured to prompt the user to download an application (e.g., an application associated with and/or hosted by the digital asset service provider computer 110). If the application has previously been installed on user computing device 606, or after a new install of the application, the transfer request may be presented to the user 608.

In some embodiments, the transfer request may include a digital image. By way of example, the transfer request may include a digital image of a personal and/or business check. The digital image may conform to attributes (e.g., color, style, font, etc.) specified by the user 604 when initiating the transfer request via the user interface 300. The transferee, user 608, may elect to print or otherwise utilize the digital image to conduct a banking deposit into his bank account. If the user 608 elects to utilize the digital image, the flow may conclude. Alternatively, the user 608 may be provided with an option to elect that the transfer amount be provided to the user 608 as a digital asset.

At step 3, the user 608 may utilize a user interface presented at the user computing device 606 to request the transfer be conducted with a digital asset. Accordingly, a digital asset request may be transmitted to digital asset service provider computer 110 at step 4. The digital asset request may include identification information of the intended transferee (e.g., the user 608). As non-limiting example, the digital asset request may include a driver's license identifier, a date of birth, a name, an address, or any suitable combination of identification information associated with the user 608.

At step 5, the digital asset request may be received by the digital asset service provider computer 110 and corresponding digital asset accounts may be generated for the user 604 and the user 608. The digital asset accounts may be associated with the corresponding identification information of the users. The digital asset service provider computer 110 may generate and/or distribute a public/private key pair for each user. The user computing device 602 and the user computing device 606 may be configured to store a received public and/or private key in local memory. Additionally, the user computing device 602 and the user computing device 606 may individually be configured to utilize the stored key(s) to digital sign subsequent transmitted data messages.

At step 6, the digital asset service provider computer 110 may generate and transmit a transaction request to financial institution computer 114. In some embodiments, the transaction request may include data associated with the first user such as authentication, account (banking and/or digital asset account) information, and/or identification information. The transaction request may further include, authentication, identification, and/or account (banking and/or digital asset account) information associated with the second user, a transfer amount, or the like. Upon receiving the transaction request, the financial institution computer 114 may authenticate user 604 and/or user 608 utilizing data contained in the received transaction request. If the user(s) are authenticated, the financial institution computer 114 may execute instructions that cause an amount of digital currency from one account (e.g., the account of the first user) to another account (e.g., a holding account of the second user) in accordance with the transaction request. The financial institution computer 114 may provide a status of the transaction within a transaction response directed to the digital asset service provider computer 110.

At step 7, the transaction response may be received by the digital asset service provider computer 110. Receipt of the transaction response may cause the digital asset service provider computer 110 to generate a digital asset (e.g., 20 Big Bucks) corresponding to the transfer amount (e.g., $20). In some cases, generating a digital asset may cause the digital asset service provider computer 110 to generate a payment method identifier (e.g., a prepaid card number) for the digital asset. The digital asset service provider computer 110 may update a ledger (e.g., a blockchain) to record the transaction. In some embodiments, the generation and assignment of the digital asset to user 604 may be recorded as one entry, and the transfer of the digital asset to the user 608 may be recorded as a separate entry within the blockchain.

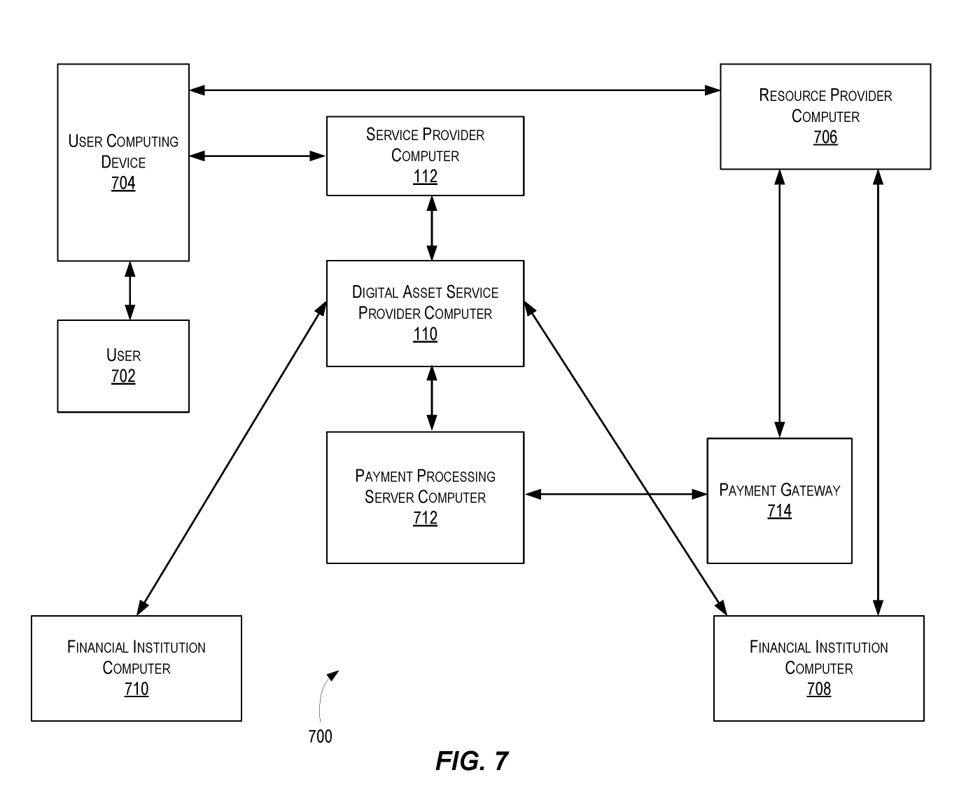

At step 8, the digital asset service provider computer 110 may send one or more notifications notify user 608 that the digital asset is available for use. In some examples, the notification may include the generated payment method identifier. The user 608 may then be enabled to utilize the digital asset in subsequent transactions (e.g., a payment transaction with a merchant) by utilizing the payment method identifier as discussed further below in connection with FIG. 7.

Embodiments of the invention enables the user 608 to receive digital assets representing fiat currency without having a direct relationship with any financial institutions. Since money received by users can be managed by digital asset service provider computer 110, the users do not need to have an account with a financial institution and thus may be unbanked. By utilizing the services provided by digital asset service provider computer 110, a user 608 may create a digital asset account that can accumulate funds owed to the user 608 by other users, entities, merchants, etc. In some cases, the funds can then be used by the user 608 for new transactions (e.g., other digital asset transfers, purchase transactions, etc.). Additionally, the digital asset service provider computer 110 enables secure transactions by utilizing a blockchain ledger that may be validated according to a cryptographic scheme. Accordingly, the transaction history may be verifiable and tamper resistant which provides a greater degree of security than conventional systems.

FIG. 7 shows an exemplary system 700 according to embodiments of the present invention. FIG. 7 includes a user 702 operating a user computing device 704, resource provider computer 706, financial institution computer 708, financial institution computer 710, digital asset service provider computer 110, service provider computer 112, payment processing server computer 712, and payment gateway 714. Digital asset service provider computer 110 may provide services as described at least with respect to FIGS. 1 and 4. In some embodiments, digital asset service provider computer 110 may be operated by payment processing server computer 712. In other embodiments, digital asset service provider computer 110 may be operated by a separate entity.

User computing device 704 may be any suitable electronic device that can process and communicate information to other electronic devices. The user computing device 704 may include a processor, input devices, output devices, and a computer readable medium coupled to the processor, the computer readable medium comprising code, executable by the processor. The user computing device 704 may include an external communication interface for communicating with other computing devices (e.g., resource provider computer 706, service provider computer 112, etc.) over a network.

User computing device 704 may be in any suitable form. For example, user computing device 704 can be hand-held and compact so that it can fit into a wallet and/or pocket (e.g., pocket-sized). Specific examples include cellular or mobile phones, tablet computers, desktop computers personal digital assistants (PDAs), pagers, portable computers, smart cards, and the like. Other examples include wearable devices (e.g., smart watches, glasses, fitness bands, ankle bracelets, rings, earrings, etc.) and automobiles with remote communication capabilities. The user computing device 704 may be configured with an application hosted by the service provider computer 112. Accordingly, the user computing device 704 may be configured to render user interfaces provided by the service provider computer 112.

Resource provider computer 706 may be one or more computers that handle processing for resource providers (e.g., merchants) that conduct transactions. In some embodiments, resource provider computers may process information received from user computing device 704 or by a mobile point-of-sale device into which user 702 provides information. Resource provider computer 706 may forward information to appropriate entities, such as financial institution computer 708, financial institution computer 710, digital asset service provider computer 110, service provider computer 112, payment processing server computer 712, and payment gateway 714. In some cases, resource provider computer 706 may host online websites or applications through with user 702 can perform transactions.

Financial institution computers 708 and 710 may be computers that are associated with financial institutions (e.g., banks) that manage money. Financial institution computer 708 may be associated with resource provider computer 706 and, in some cases, may manage a banking account on behalf of the resource provider associated with the resource provider computer 706. Financial institution computer 710 may be associated with the same or different institution as financial institution computer 708. In some embodiments, financial institution computer 710 may not manage bank accounts for the user 702 and/or the resource provider associated with resource provider computer 706. In some embodiments, financial institution computer 710 may hold money associated with digital assets assigned to the user 702 by the digital asset service provider computer 110.

Payment processing server computer 712, an example of the authorization service computer 116 of FIG. 1, may include a server computer used for payment processing. In some embodiments, payment processing server computer 712 may be coupled to a database and may include any hardware, software, other logic, or combination of the preceding for servicing the requests from one or more client computers. Payment processing server computer 712 may comprise one or more computational apparatuses and may use any of a variety of computing structures, arrangements, and compilations for servicing the requests from one or more client computers. In some embodiments, payment processing server computer 712 may operate multiple server computers. In such embodiments, each server computer may be configured to process transaction for a given region or handles transactions of a specific type based on transaction data.

Payment processing server computer 712 may include data processing subsystems, networks, and operations used to support and deliver authorization services, exception file services, and clearing and settlement services. An exemplary payment processing server computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The payment processing server computer may use any suitable wired or wireless network, including the Internet.

Payment processing server computer 712 may process transaction-related messages (e.g., authorization request messages and authorization response messages) and determine the appropriate destination computer for the transaction-related messages. In some embodiments, the payment processing server computer may authorize transactions on behalf of an authorization computer. Payment processing server computer 712 may also handle and/or facilitate the clearing and settlement of financial transactions.

Payment gateway 714 may be a server computer that facilitates information from a payment portal to another processing entity. For example, payment gateway 714 may transfer information received from resource provider computer 706 to payment processing server computer 712. In some embodiments, payment gateway 714 may receive the information from an online website hosted by resource provider computer 706.

The exemplary system 700 that may be used for conducting a payment transaction utilizing a digital asset. The transaction may be conducted between user 702 and resource provider computer 706. User 702 and the resource provider associated with the resource provider computer 706 may be enrolled with and have digital asset accounts maintained by digital asset service provider computer 110.

User 702 may be previously assigned a digital asset by digital asset service provider computer 110. The digital asset may be funded by funds submitted by the user 702 (e.g., from a bank account associated with the user 702) or the digital asset may be assigned to the user 702 as a result of one or more previous transfers from one or more other users. Additionally, a payment method identifier (e.g., a prepaid card number) may have been generated and assigned to the digital asset (or the digital asset account of the user 702). Accordingly, the user 702 may conduct a payment transaction with resource provider computer 706 using the payment method identifier. By way of example, user 702 may utilize user computing device 704 to access a payment portal hosted by the resource provider computer 706 (e.g., a website for selling goods). Upon accessing the payment portal, the user 706 may provide the payment method identifier associated with his digital asset account. An authorization request for the payment transaction may be processed by payment gateway 714 and payment processing server computer 712.

In some embodiments, the digital asset service provider computer 110 may be configured to verify that the digital assets associated with the digital asset account of the user 702 has sufficient digital assets to perform the payment transaction. If the digital assets are equal to or exceed the amount needed to conduct the payment transaction, the digital asset service provider computer 110 may be configured to cause the payment transaction to be approved and the resource provider computer 706 to be notified. If the digital assets are not sufficient to perform the payment transaction, the digital asset provider computer 110 may be configured to cause the payment transaction to be declined and the resource provider computer 706 to be notified.

At the end of the day, a settlement process can be performed in which digital asset service provider computer 110 sends a request to financial institution computer 710 to move a transaction amount corresponding to the payment transaction from a holding account associated with the user 702 (managed by the financial institution computer 710) to a banking account of resource provider computer 706 (managed by the financial intuition computer 708).

The various participants and elements described herein may operate one or more computer apparatuses to facilitate the functions described herein. Any of the elements in the above-described figures, including any servers or databases, may use any suitable number of subsystems to facilitate the functions described herein.

A computer system may be utilized to implement any of the entities or components described above. Subsystems of the computer system may be interconnected via a system bus. Additional subsystems may include a printer, a keyboard, a fixed disk (or other memory comprising computer readable media), a monitor, which is coupled to a display adapter, and others. Peripherals and input/output (I/O) devices, which couple to an I/O controller (which can be a processor or other suitable controller), can be connected to the computer system by any number of means known in the art, such as by a serial port. For example, the serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer readable medium. In some embodiments, the monitor may be a touch sensitive display screen.

Specific details regarding some of the above-described aspects are provided above. The specific details of the specific aspects may be combined in any suitable manner without departing from the spirit and scope of embodiments of the technology. For example, back end processing, data analysis, data collection, and other transactions may all be combined in some embodiments of the technology. However, other embodiments of the technology may be directed to specific embodiments relating to each individual aspect, or specific combinations of these individual aspects.

It should be understood that the present technology as described above can be implemented in the form of control logic using computer software (stored in a tangible physical medium) in a modular or integrated manner. While the present invention has been described using a particular combination of hardware and software in the form of control logic and programming code and instructions, it should be recognized that other combinations of hardware and software are also within the scope of the present invention. Based on the disclosure and teachings provided herein, a person of ordinary skill in the art will know and appreciate other ways and/or methods to implement the present technology using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

In some embodiments, any of the entities described herein may be embodied by a computer that performs any or all of the functions and steps disclosed.

One or more features from any embodiment may be combined with one or more features of any other embodiment without departing from the scope of the technology.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer, a transfer request associated with a first user, the transfer request comprising authentication information associated with the first user, first identification information associated with the first user, an identifier associated with a second user, and a transfer amount;
validating, by the server computer, the transfer request utilizing the first authentication information;
transmitting, by the server computer, the transfer request to a computing device of the second user utilizing the identifier associated with the second user;
receiving, by the server computer, a digital asset request comprising second identification information associated with the second user and a digital asset amount related to the transfer amount;
transmitting, by the server computer, a transaction request to an financial institution computer, the transaction request comprising the first identification information, the second identification information, and the transfer amount;
receiving, by the server computer, a transaction response corresponding to the transaction request;
generating, by the server computer, a digital asset corresponding to the digital asset amount utilizing the first identification information, the digital asset being associated with a first digital asset account of the first user;
transferring, by the server computer, the digital asset from the first digital asset account of the first user to a second digital asset account of the second user utilizing the first identification information and the second identification information; and
maintaining, by the server computer, a blockchain ledger of transactions to indicate the transfer of the digital asset from the first digital asset account of the first user to the second digital asset account of the second user.

2. The method of claim 1, further comprising:
generating, by the server computer, a payment method identifier associated with the digital asset account of the second user;
receiving, by the server computer, an authorization request comprising the payment method identifier and a resource provider identifier; and
facilitating, by the server computer utilizing the payment method identifier, an asset transfer between the digital asset account of the second user and a financial account associated with the resource provider identifier.

3. The method of claim 1, wherein the first authentication information comprises a digital signature of the first user that is verifiable using a public key associated with the first user, the public key being maintained as part of the digital asset account of the first user.

4. The method of claim 1, wherein the first identification information associated with the first user comprises at least one of: an account number, a name, an address, a social security number, or a date of birth.

5. The method of claim 1, wherein the second identification information associated with the second user comprises at least one of: a driver's license number, a name, an address, a social security number, or a date of birth.

6. The method of claim 1, wherein the blockchain ledger of transactions is updated to include an entry comprising the first identification information, first data associated with the first digital asset account, the second identification information, second data associated with the second digital asset account, and the digital asset amount.

7. The method of claim 1, wherein the computing device of the second user comprises an application associated with the digital asset account of the second user.

8. The method of claim 1, wherein transmitting the transfer request to the computing device associated with a second user utilizes a text messaging protocol.

9. The method of claim 1, wherein transmitting the transaction request message to the financial institution computer causes the financial institution computer to:
create a holding account on behalf of the second user; and
transfer the transfer amount from a financial account of the first user to the holding account.

10. The method of claim 1, wherein the transfer request associated with the first user is received from an application executing on a user device of the first user.

11. A server computer comprising,
a processor, and
a computer readable medium coupled to the processor, the computer readable medium comprising code for causing the processor to:
receive a transfer request associated with a first user, the transfer request comprising authentication information associated with the first user, first identification information associated with the first user, an identifier associated with a second user, and a transfer amount;
validate the transfer request utilizing the first authentication information;
transmit the transfer request to a computing device of the second user utilizing the identifier associated with the second user;
receive a digital asset request comprising second identification information associated with the second user and a digital asset amount related to the transfer amount;
transmit a transaction request to an financial institution computer, the transaction request comprising the first identification information, the second identification information, and the transfer amount;
receive a transaction response corresponding to the transaction request;
generate a digital asset corresponding to the digital asset amount utilizing the first identification information, the digital asset being associated with a first digital asset account of the first user;
transfer the digital asset from the first digital asset account of the first user to a second digital asset account of the second user utilizing the first identification information and the second identification information; and
maintain a blockchain ledger of transactions to indicate the transfer of the digital asset from the first digital asset account of the first user to the second digital asset account of the second user.

12. The server computer of claim 11, wherein the computer readable medium comprises additional code for causing the processor to:
generate a payment method identifier associated with the digital asset account of the second user;
receive an authorization request comprising the payment method identifier and a resource provider identifier; and
facilitate, utilizing the payment method identifier, an asset transfer between the digital asset account of the second user and a financial account associated with the resource provider identifier.

13. The server computer of claim 11, wherein the first authentication information comprises a digital signature of the first user that is verifiable using a public key associated with the first user, the public key being maintained as part of the digital asset account of the first user.

14. The server provider computer of claim 11, wherein the first identification information associated with the first user comprises at least one of: an account number, a name, an address, a social security number, or a date of birth.

15. The server computer of claim 11, wherein the second identification information associated with the second user comprises at least one of: a driver's license number, a name, an address, a social security number, or a date of birth.

16. The server computer of claim 11, wherein the blockchain ledger of transactions is updated to include an entry comprising the first identification information, first data associated with the first digital asset account, the second identification information, second data associated with the second digital asset account, and the digital asset amount.

17. The server computer of claim 11, wherein transmitting the transfer request to the computing device associated with a second user utilizes a text messaging protocol.

18. The server computer of claim 11, wherein transmitting the transaction request message to the financial institution computer causes the financial institution computer to:
create a holding account on behalf of the second user; and
transfer the transfer amount from an electronic account of the first user to the holding account.

19. A user computing device comprising,
a display;
a processor; and
a computer readable medium coupled to the processor, the computer readable medium comprising code for causing the processor to:
receive, from a server computer, a transfer request associated with a transferor, the transfer request comprising a transfer amount;
provide an option to request the transfer amount to be provided as a digital asset, the option being provided to a user of the user computing device utilizing the display;
receive user input indicating that the option has been selected;
collect user identification information of the user;
transmit, to the server computer, a digital asset request comprising the user identification information and a digital asset amount related to the transfer amount, wherein receipt of the digital asset request causes the digital asset service provider computer to facilitate a transfer of the digital asset from the transferor to the user utilizing a blockchain ledger of transactions;
receive notification that the digital asset has been transferred; and
present the notification to the user at the display.

20. The user computing device of 19, wherein facilitating a transfer of the digital asset further comprises:
transmitting a transaction request from the server computer to a financial institution computer, the transaction request causing the financial institution to:
maintain a holding account on behalf of the user; and
transfer digital currency corresponding to the transfer amount from a financial account of the transferor to the holding account; and
receive, by the server computer from the financial account, a transaction response corresponding to the transaction request, the transaction response indicating a status associated with the transaction request.
